(19) United States
(12) Patent Application Publication
(10) Pub. No.: US 2014/0210727 A1
(43) Pub. Date: Jul. 31, 2014

(54) ELECTRONIC DEVICE WITH TOUCH-BASED DEACTIVATION OF TOUCH INPUT SIGNALING

(71) Applicant: Tomas Karl-Axel Wassingbo, Malmo (SE)

(72) Inventor: Tomas Karl-Axel Wassingbo, Malmo (SE)

(73) Assignee: Sony Ericsson Mobile Communications AB, Lund (SE)

(21) Appl. No.: 13/575,621

(22) PCT Filed: Oct. 11, 2011
(86) PCT No.: PCT/IB2011/002385

§ 371 Date: Jul. 27, 2012

Related U.S. Application Data
(60) Provisional application No. 61/542,643, filed on Oct. 3, 2011.

(51) Int. Cl. G06F 3/041

(52) U.S. Cl. CPC G06F 3/041
USPC 345/173

(57) ABSTRACT

To enhance user interaction with an electronic device having a touch screen, the electronic device permits touch-based user input even if the user inadvertently rests a thumb or finger on the touch screen.

### RELATED APPLICATION DATA

This application claims the benefit of U.S. Provisional Patent Application No. 61/542,643 filed Oct. 3, 2011, the disclosure of which is incorporated herein by reference in its entirety.

### TECHNICAL FIELD OF THE INVENTION

The technology of the present disclosure relates generally to electronic devices with touch screens and, more particularly, to techniques for enhancing operation of touch screens.

### BACKGROUND

Electronic devices have a variety of user interfaces, such as keypads and touch screens. Touch screens are particularly popular for portable electronic devices, such as mobile telephones and tablet computing devices. One drawback to touch screens is how the device reacts to sustained touching of the touch screen. On some electronic devices, the sustained touching prevents use of all other touch functionality. For example, if a user were to accidently leave a thumb against the touch screen while holding the device, the touch screen will not accept user input by touching of the screen with fingers from the user's other hand. On other electronic devices, the sustained touching prevents use of all other touch functionality in a window in which the sustained touching occurs but touch functionality in other displayed windows is possible. In some instances, if the sustained touching is on an area that has an associated touch function, the touch function is carried out when the touching ceases (e.g., the finger or thumb is released).

As an example of the results of this reaction to sustained touching of the touch screen, suppose a user were reading an electronic newspaper on a tablet computing device while holding the device in the user's left hand such that the user's left thumb rests on the touch screen. The sensing of the left thumb on the touch screen would “lock-out” other touch inputs. This would prevent, for example, the user from using his or her right index finger to enter scroll commands by interaction with a displayed slider or by swiping across the touch screen, or from touch selecting a link presented in the displayed text.

### SUMMARY

To enhance user interaction with an electronic device, the present disclosure describes a touch-based user input technique for using a touch screen even if the user inadvertently rests a thumb or finger on the touch screen.

According to one aspect of the disclosure, an electronic device includes a touch sensitive display configured to display visual content containing selectable items to a user and receive user touch input to select the selectable items from the displayed visual content; and a control circuit configured to detect touching of the touch sensitive display in a displayed window and time the duration of the touching and, when the touching exceeds a predetermined deactivation threshold duration: deactivate the touch selectability of selectable items displayed on the touch sensitive display for an area of the display overlapped by the touching that exceeds the predetermined deactivation threshold duration; and permit the touch selectability of selectable items displayed on the touch sensitive display for areas of the window other than the area of the display overlapped by the touching that exceeds the predetermined length of time.

According to an embodiment of the electronic device, the control circuit is further configured to, when the duration of the touching is less than a predetermined select threshold duration and corresponds in location to one of the selectable items, execute a select action for the selectable item.

According to an embodiment of the electronic device, the touching corresponds in location to a selectable item that is further associated with a long-press action and the control circuit is further configured to execute the long-press action when the touching is of a duration greater than the predetermined select threshold duration and less than the predetermined long press threshold.

According to an embodiment of the electronic device, the deactivated area has a contour matched to an area sensed as being touched by the touching that exceeds the predetermined deactivation threshold duration.

According to an embodiment of the electronic device, the deactivated area has a contour larger than the area sensed as being touched by the touching that exceeds the predetermined deactivation threshold duration and smaller than the window.

According to an embodiment of the electronic device, the control circuit includes a processor to execute actions associated with the selectable items, and a touch input signal analyzer that analyzes signals generated by the touch sensitive display in response to touching of the touch sensitive display and outputs corresponding control signals to the processor.

According to an embodiment of the electronic device, when the touching exceeds the predetermined deactiviation threshold duration, the touch input signal analyzer does not output control signals for touching of the deactivated area.

According to an embodiment of the electronic device, release of the deactivated area after the predetermined deactivation threshold duration does not result in executing an action associated with any selectable item within the deactivated area.

According to an embodiment of the electronic device, the control circuit is further configured to detect release of the touching that exceeds the predetermined deactivation threshold duration and reactivate the deactivated area to permit touch selectability of items displayed on the display in the deactivated area.

### BRIEF DESCRIPTION OF THE DRAWINGS

FIG. 1 is a front view of an electronic device according to aspects of the invention shown while a user interacts with a touch screen of the electronic device and holds the electronic device;

FIG. 2 is a front view of the electronic device of FIG. 1 shown while the user interacts with the touch screen of the electronic device and holds the electronic device in a manner that results in inadvertent sustained touching of the touch screen;

FIG. 3 is a schematic block diagram of the electronic device as part of a communication network;

FIG. 4 is a timeline depicting operation of the electronic device for touching of the touch screen for various durations; and

FIG. 5 is an exemplary flow diagram of touch-based operation of the electronic device.

### DETAILED DESCRIPTION OF EMBODIMENTS

Embodiments will now be described with reference to the drawings, wherein like reference numerals are used to refer to like elements throughout. It will be understood that the figures are not necessarily to scale. Features that are described and/or illustrated with respect to one embodiment may be used in the same way or in a similar way in one or more other embodiments and/or in combination with or instead of the features of the other embodiments.

Described below in conjunction with the appended figures are various embodiments of controlling a portable electronic device that includes a touch screen. The electronic device may take any form factor including, but not limited to, a tablet computing device (e.g., an “iPad” available from Apple Inc. or a “Galaxy Tab” available from Samsung Electronics), a mobile telephone (e.g., an “Xperia” smartphone available from Sony Ericsson Mobile Communications AB), a laptop computer, a gaming device, a camera, a television, a computer display, and a media player. The illustrated example shows a mobile telephone, but applicability of aspects of the invention is not limited to mobile telephones.

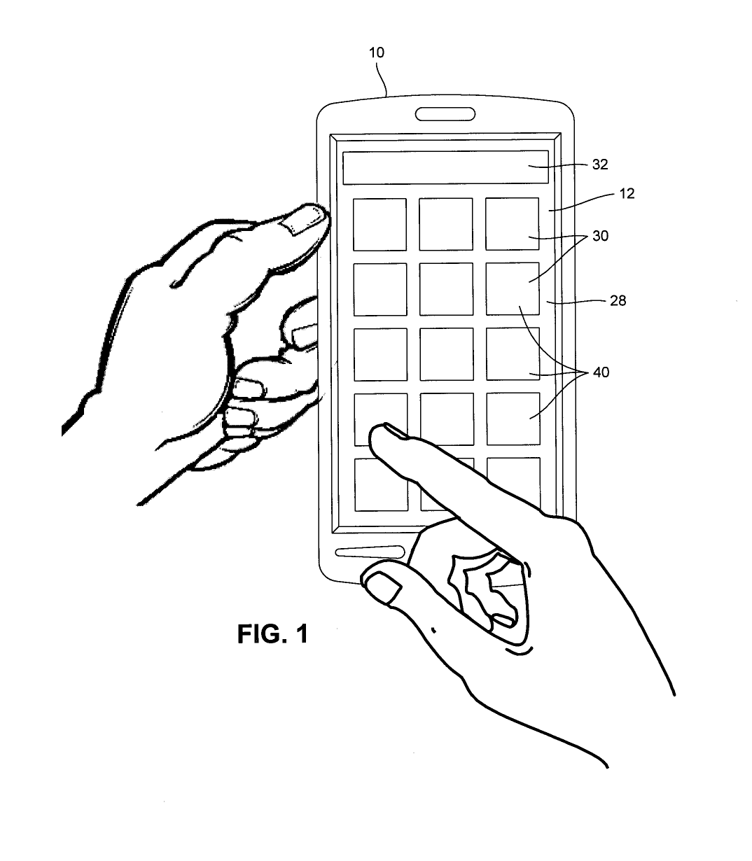

Referring to FIGS. 1 through 3, an electronic device 10 is shown. The electronic device 10 includes a touch sensitive display 12 (also referred to as a touch screen) for displaying displayable content associated with applications 14 that are executed by the electronic device 10 and for receiving touch-based user input. Exemplary applications 14 may include, but are not limited to, an operating system, a media player for playing video and/or audio, an image viewer for displaying images, an Internet browser, an electronic mail application, an instant messaging application, a text messaging application, a multimedia messaging application, a word processing application or viewer, a spreadsheet application or viewer, a game, a camera operation application, a contact list function, a calendar function, a keypad or keyboard function, and any other application or function that may be executed by the electronic device 10.

The touch sensitive display 12 includes a display 16 (e.g., a liquid crystal display or LCD) to generate displayed visual content. The touch sensitive display 12 also includes a touch sensor 18 overlaid on the display 16. The touch sensor 18 is sensitive to touching by a user and generates output signals corresponding to sensed touching. Touch sensors 18, such as resistive touch screen sensors and capacitive touch screen sensors, are relatively well-known in the art and will not be described in detail.

The signals output by the touch sensor 18 are input to a control circuit 20. In one embodiment, the control circuit 20 includes a touch input signal analyzer 22 to which the signals output by the touch sensor 18 are input. The touch input signal analyzer 22 conducts initial analysis of the input signals from the touch sensor 18 and generates control signals that are output to a processor 24 of the control circuit 20. In one embodiment, the processor 24 is responsible for overall operation of the electronic device 10 by executing the various applications 14. The processor 24 also executes a user input function 26 that is responsive to the control signals from the touch input signal analyzer 22.

The displayed visual content may be displayed in one or more windows 28. For example, in FIG. 1, the electronic device 10 is in an operational mode in which one window 28 is displayed. In the illustrated example, the window 28 occupies the entire display 12 and corresponds to a home screen generated by an operating system. The home screen shows various icons 30, which are typically used for launching applications, and a status bar 32.

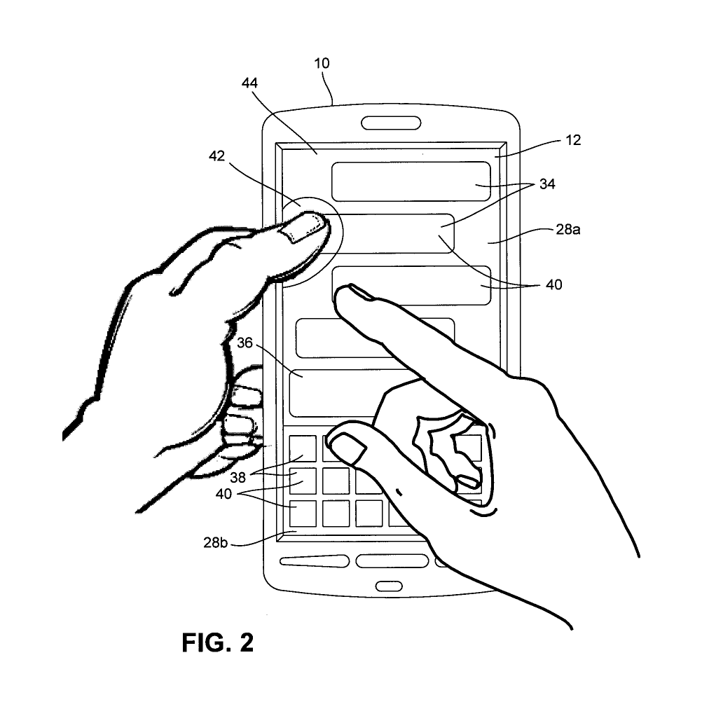

As another example, in FIG. 2, the electronic device 10 is in an operational mode in which two windows 28 (shown as windows 28a and 28b) are displayed. In the illustrated example, window 28a corresponds to a text message function and shows a log of text messages 34 from a text message string and a text entry field 36 used for composition of a new message. Window 28b corresponds to a keyboard function and shows keys 38 used for selecting characters (e.g., letters, numbers, symbols, emoticons, etc.).

With additional reference to FIG. 4, some displayed items are selectable items 40. Selecting a selectable item 40 results in the processor 24 executing a portion of a corresponding application 14 to carry out an action appropriate for the selection. Selecting a selectable item 40 includes user touching of the selectable item 40 (e.g., with a fingertip) for a period of time less than or equal to a predetermined select threshold duration (t1 in the appended figures). The predetermined select threshold duration t1 may be, for example, about half a second. The touching is measured from the time that the touching is initially sensed to a point where touching is no longer sensed, which represents a release of the touch sensitive display 12 by the user. In the illustrated embodiments, selectable items 40 include the icons 30 (whose selection results in launching a corresponding application 14), the messages 34 (whose selection allows copying of the text from the display message 34), the text entry field 36 (whose selection results in placement of a cursor at the point of touching), and the keys 38 (whose selection results in entry of a corresponding character in the text entry field 36). Other exemplary selectable items 40 include, but are not limited to, scroll bars, buttons (e.g., an “OK” button, a “cancel” button, etc.), menu or list entries, links (e.g., link to webpages), etc.

In addition to being associated with a selection action, some selectable items 40 may be associated with a long-press action. For instance, in one embodiment, each icon 30 has a select action to launch an application corresponding to the icon 40 and a long-press action that allows the icon to be repositioned relative to other icons 40, deleted or moved into a folder. Other exemplary long-press actions include, but are not limited to, closing a window 28, displaying a menu with additional selectable items 40, etc.

In one embodiment, selecting a selectable item 40 to carry out an associated long-press action includes user touching of the selectable item 40 (e.g., with a fingertip) for a period of time longer than or equal to a predetermined long-press threshold duration (t2 in the appended figures) and for a period of time shorter than or equal to a predetermined deactivation threshold duration t3 (t3 in the appended figures). In one embodiment, the predetermined long-press threshold duration t2 is longer than the predetermined select threshold duration t1. In this embodiment, if touching lasts for a period of time between the predetermined select threshold duration t1 and the predetermined long-press threshold duration t2, then no action will be carried out. This allows for distinguishing between a user desire to select an item for carrying out the select action and a user desire to select an item for carrying out the long-press action. In one embodiment, the predetermined long-press threshold duration t2 may be about three quarters of a second to about one second. In other embodiments, the predetermined long-press threshold duration t2 is equal to the predetermined select threshold duration t1 so that touching for shorter than the predetermined select threshold duration t1 results in carrying the select action and touching for a period of time between predetermined select threshold duration t1 (the same as the predetermined long-press threshold duration t2) and the predetermined deactivation threshold duration t3 results in carrying out the long-press action.

If touching of the display lasts for longer than the predetermined deactivation threshold duration t3, then a deactivate function may be carried out. As part of the deactivate function, the touch selectability of selectable items 40 displayed on the touch sensitive display 12 for an area 42 (FIG. 2) of the display 12 overlapped by the touching that exceeds the predetermined deactivation threshold duration t3 may be deactivated. In one embodiment, when the touching exceeds the predetermined deactiviation threshold duration t3, the touch input signal analyzer 22 will not output control signals corresponding to any sensed touching that falls within the deactivated area 42. As a result, when the user releases the deactivated area 42, the release does not result in executing a select action or a long-press action associated with any selectable item 40 within the deactivated area 42. But, once there is a release of the touching that exceeds the predetermined deactivation threshold duration t3, the deactivated area 42 may be re-activated. This returns the touch selectability of selectable items 40 displayed on the display 12 in the deactivated area 42 to once again be selected (e.g., a selectable state). In one embodiment, the predetermined deactivation threshold duration t3 is about two seconds.

In one embodiment, the deactivated area 42 has a contour (e.g., a size and shape) that is matched to an area sensed as being touched by the touching that exceeds the predetermined deactivation threshold duration t3. In another embodiment, such as the embodiment illustrated in FIG. 2, the deactivated area 42 has a contour that is larger than the area sensed as being touched by the touching that exceeds the predetermined deactivation threshold duration t3. In this embodiment, the deactivated area 42 is of approximately the same shape as the touched area and does not consume the entire window 28. For example, the deactivated area 42 may have an area (e.g., in square millimeters) that is no larger than twice the area of the touched area. This allows for slight moving of the finger or thumb that is touching the display 12 for longer than the predetermined deactivation threshold duration t3 without selecting a nearby selectable item 40. If a selectable item 40 partially overlaps with the touched area (e.g., as illustrated in FIG. 2), the deactivated area 42 may be enlarged to encompass the entire overlapping selectable item 40 or the deactivated area 42 may not be altered from following the contour of the touched area (e.g., only a portion of the selectable item 40 is deactivated).

While the deactivated area 42 is deactivated, the touch selectability of selectable items 40 displayed on the touch sensitive display 12 in areas 44 of the window 28 other than the deactivated area 42 will remain active. Therefore, the user will be permitted to touch selected a selectable item 40 in the window 28 containing the deactivated area 42 and the associated select action or, if applicable, the associated long-press action will be carried out.

In one embodiment, the described behavior of the touch sensitive display 12, including signal analysis and control operations responsive to the user touching of the display 12, may be embodied in the form of executable logic (e.g., lines of code, software, or a program) that is stored on a computer readable medium (e.g., a memory) of the electronic device 10 and executed by the control circuit 20. The described behavior may be thought of as a method that is carried out by the electronic device 10. Variations to the illustrated and described techniques are possible and, therefore, the disclosed embodiments should not be considered the only manner of carrying out electronic device 10 control techniques. Also, while the appended figures show exemplary displayed visual content, the content may be different than that shown.

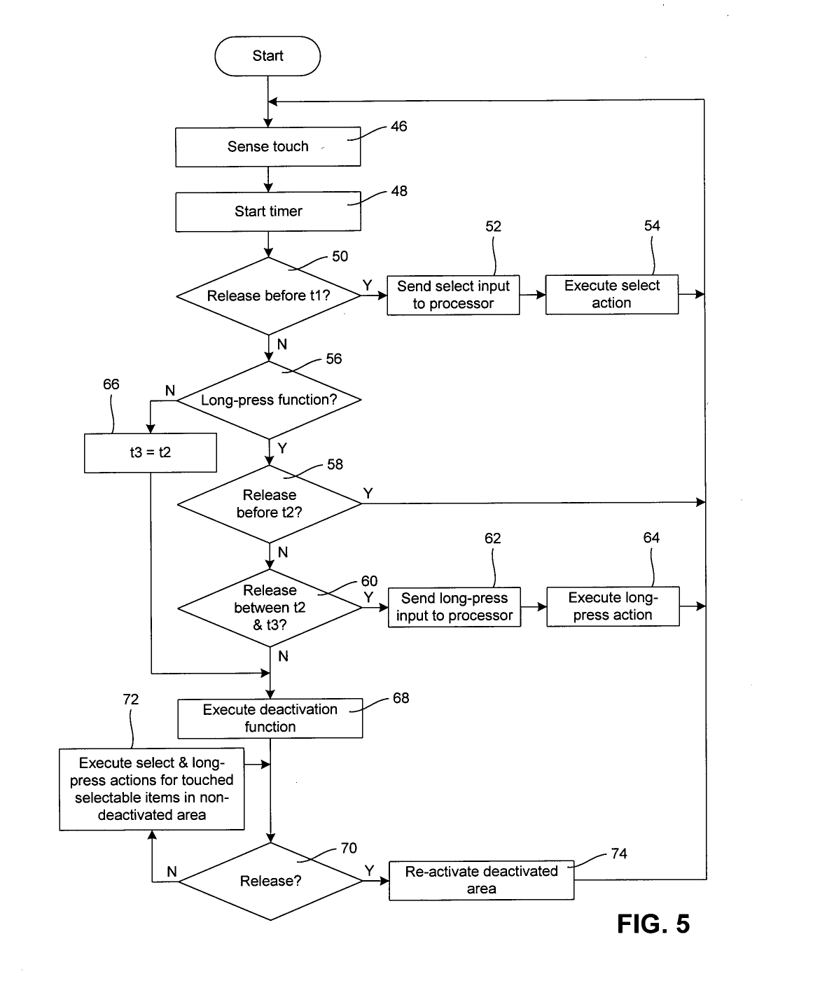

With additional reference to FIG. 5, illustrated is an exemplary flow diagram representing steps that may be carried out to implement the disclosed behavior of the touch sensitive display 12. Although illustrated in a logical progression, the illustrated blocks may be carried out in other orders and/or with concurrence between two or more blocks. Therefore, the illustrated flow diagram may be altered (including omitting steps) and/or may be implemented in an object-oriented manner or in a state-oriented manner.

The logical flow may commence in block 46 where touching of the touch sensitive display 12 is sensed. In block 48, the sensed touching starts the running of a timer. If, in block 50, the user releases the touch sensitive display 12 before the timer reaches the predetermined select threshold duration t1, the logical flow may proceed to block 52. In block 52, the touch input signal analyzer 22 may output a command to the processor 24 to execute a select action for a touched selectable item 40. In block 54, the processor 24 executes the select action that is associated with the selected item 40. In cases where the touching does not occur in the position of selectable item 40, a positive result may still result in block 50 but no select action is executed in block 54. Following block 54, the logical flow may return to block 46 to await the sensing of another touch input.

If a negative determination is made in block 50, the logical flow may proceed to block 56. In block 56 a determination is made as to whether the touch input corresponds to a location that has a selectable item 40 that is associated with a long-press action. If so, the logical flow may proceed to block 58 where a determination may be made as to whether the user releases the touch sensitive display 12 before the predetermined long-press threshold duration t2. If a positive determination is made in block 58, the logical flow may return to block 46 to await the sensing of another touch input. If a negative determination is made in block 58, the logical flow may proceed to block 60 where a determination is made as to whether the user releases the touch sensitive display 12 between the predetermined long-press threshold duration t2 and the predetermined deactivation threshold duration t3. If a positive determination is made in block 60, the logical flow may proceed to block 62. In block 62, the touch input signal analyzer 22 may output a command to the processor 24 to execute a long-press action for the touched selectable item 40. In block 64, the processor 24 executes the long-press action that is associated with the selected item 40. Following block 64, the logical flow may return to block 46 to await the sensing of another touch input.

Following a negative determination in block 56 (meaning that the touched position of the touch sensitive display 12 is not associated with a selectable item 40 having an associated long-press action), the logical flow may proceed to block 66. In block 66, the predetermined deactivation threshold duration t3 may be set to equal the predetermined long-press threshold duration t2, thereby compressing the timeline of FIG. 4. Alternatively, no alteration to the predetermined deactivation threshold duration t3 may be made.

Following block 66 or following a negative determination in block 60, the logical flow may proceed to block 68. In block 68, a deactivation function may be carried out to establish the deactivated area 42. Next, the logical flow enters a loop at block 70 to wait for release of the touch sensitive display 12. During the loop at block 70, touch selection of selectable items 40 in the area 44 of the window 28 containing the deactivated area 42 will be carried out at block 72. Upon release of the touching of the touch sensitive display 12 that exceeded the predetermined deactivation threshold duration t3, the logical flow will proceed to block 74. In block 74, the touch selectivity of the deactivated area 42 will be returned to normal to accept touch inputs in the entire affected window 28. Following block 74, the logical flow may return to block 46 to await the sensing of another touch input.

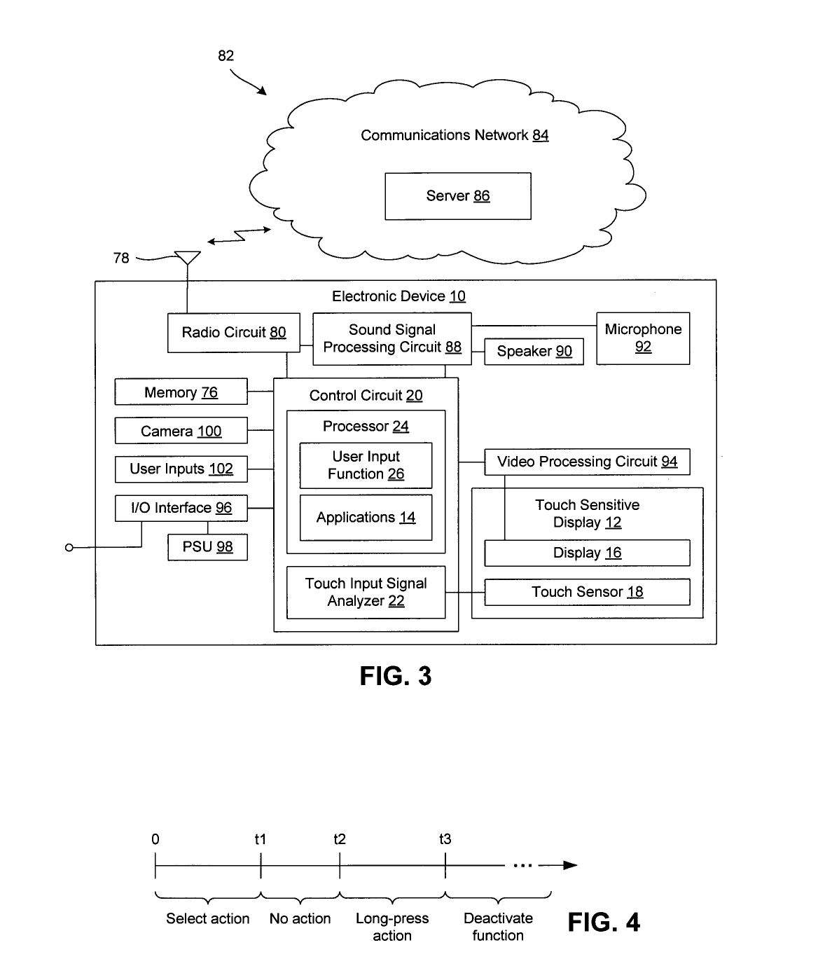

With continuing reference to FIG. 3, the electronic device 10 may include communications circuitry that enables the electronic device 10 to establish communication with another device. Communications may include voice calls, video calls, data transfers, and the like. Communications may occur over a cellular circuit-switched network or over a packet-switched network (e.g., a network compatible with IEEE 802.11, which is commonly referred to as WiFi, or a network compatible with IEEE 802.16, which is commonly referred to as WiMAX). Data transfers may include, but are not limited to, receiving streaming content, receiving data feeds, downloading and/or uploading data (including Internet content), receiving or sending messages (e.g., text messages, instant messages, electronic mail messages, multimedia messages), and so forth. This data may be processed by the electronic device 10, including storing the data in a memory 76, executing applications to allow user interaction with the data, displaying video and/or image content associated with the data, outputting audio sounds associated with the data, and so forth.

In the exemplary embodiment, the communications circuitry may include an antenna 78 coupled to a radio circuit 80. The radio circuit 80 includes a radio frequency transmitter and receiver for transmitting and receiving signals via the antenna 78. The radio circuit 80 may be configured to operate in a mobile communications system 82. Radio circuit 80 types for interaction with a mobile radio network include, but are not limited to, global system for mobile communications (GSM), code division multiple access (CDMA), wideband CDMA (WCDMA), general packet radio service (GPRS), WiFi, WiMAX, integrated services digital broadcasting (ISDB), high speed packet access (HSPA), Bluetooth, etc., as well as advanced versions of these standards or any other appropriate standard. It will be appreciated that the electronic device 10 may be capable of communicating using more than one standard. Therefore, the antenna 78 and the radio circuit 80 may represent one or more than one radio transceiver.

The system 82 may include a communications network 84 having a server 86 (or servers) for managing calls placed by and destined to the electronic device 10, transmitting data to and receiving data from the electronic device 10, and carrying out any other support functions. The server 86 communicates with the electronic device 10 via a transmission medium. The transmission medium may be any appropriate device or assembly, including, for example, a communications base station (e.g., a cellular service tower, or “cell” tower), a wireless access point, a satellite, etc. The network 84 may support the communications activity of multiple electronic devices 10 and other types of end user devices. As will be appreciated, the server 86 may be configured as a typical computer system used to carry out server functions and may include a processor configured to execute software containing logical instructions that embody the functions of the server 86 and a memory to store such software. In alternative arrangements, the electronic device 10 may wirelessly communicate directly with another electronic device and without an intervening network.

As indicated, the electronic device 10 may include the primary control circuit 20 that is configured to carry out overall control of the functions and operations of the electronic device 10. The processor 24 may be a central processing unit (CPU), microcontroller or microprocessor. The processor 24 executes code stored in a memory (not shown) within the control circuit 20 and/or in a separate memory, such as the memory 76, in order to carry out operation of the electronic device 10. The memory 76 may be, for example, one or more of a buffer, a flash memory, a hard drive, a removable media, a volatile memory, a non-volatile memory, a random access memory (RAM), or other suitable device. In a typical arrangement, the memory 76 may include a non-volatile memory for long term data storage and a volatile memory that functions as system memory for the control circuit 20. The memory 76 may exchange data with the control circuit 20 over a data bus. Accompanying control lines and an address bus between the memory 76 and the control circuit 20 also may be present.

The electronic device 10 further includes a sound signal processing circuit 88 for processing audio signals. Coupled to the sound processing circuit 88 are a speaker 90 and a microphone 92 that enable a user to listen and speak via the electronic device 10, and hear sounds generated in connection with other functions of the device 10. The sound processing circuit 88 may include any appropriate buffers, encoders, decoders, amplifiers and so forth.

The display 16 may be coupled to the control circuit 20 by a video processing circuit 94 that converts video data to a video signal used to drive the display 16. The video processing circuit 94 may include any appropriate buffers, decoders, video data processors and so forth.

The electronic device 10 may further include one or more input/output (I/O) interface(s) 96. The I/O interface(s) 96 may be in the form of typical electronic device I/O interfaces and may include one or more electrical connectors for operatively connecting the electronic device 10 to another device (e.g., a computer) or an accessory (e.g., a personal handsfree (PHF) device) via a cable. Further, operating power may be received over the I/O interface(s) 96 and power to charge a battery of a power supply unit (PSU) 98 within the electronic device 10 may be received over the I/O interface(s) 96. The PSU 98 may supply power to operate the electronic device 10 in the absence of an external power source.

The electronic device 10 also may include various other components. For instance, a camera 100 may be present for taking digital pictures and/or movies. Image and/or video files corresponding to the pictures and/or movies may be stored in the memory 76. User inputs 102 other than the touch sensor 18 may be present. Exemplary user inputs 102 may include buttons and motion sensors (e.g., gyro sensors, accelerometers). A position data receiver (not shown), such as a global positioning system (GPS) receiver, may be involved in determining the location of the electronic device 10.

Although certain embodiments have been shown and described, it is understood that equivalents and modifications falling within the scope of the appended claims will occur to others who are skilled in the art upon the reading and understanding of this specification.

1. An electronic device, comprising:
a touch sensitive display configured to display visual content containing selectable items to a user and receive user touch input to select the selectable items from the displayed visual content; and
a control circuit configured to detect touching of the touch sensitive display in a displayed window and time the duration of the touching and, when the touching exceeds a predetermined deactivation threshold duration:
deactivate the touch selectability of selectable items displayed on the touch sensitive display for an area of the display overlapped by the touching that exceeds the predetermined deactivation threshold duration; and
permit the touch selectability of selectable items displayed on the touch sensitive display for areas of the window other than the area of the display overlapped by the touching that exceeds the predetermined length of time.

2. The electronic device of claim 1, wherein the control circuit is further configured to, when the duration of the touching is less than a predetermined select threshold duration and corresponds in location to one of the selectable items, execute a select action for the selectable item.

3. The electronic device of claim 2, wherein the touching corresponds in location to a selectable item that is further associated with a long-press action and the control circuit is further configured to execute the long-press action when the touching is of a duration greater than the predetermined select threshold duration and less than the predetermined long press threshold.

4. The electronic device of claim 1, wherein the deactivated area has a contour matched to an area sensed as being touched by the touching that exceeds the predetermined deactivation threshold duration.

5. The electronic device of claim 1, wherein the deactivated area has a contour larger than the area sensed as being touched by the touching that exceeds the predetermined deactivation threshold duration and smaller than the window.

6. The electronic device of claim 1, wherein the control circuit includes a processor to execute actions associated with the selectable items, and a touch input signal analyzer that analyzes signals generated by the touch sensitive display in response to touching of the touch sensitive display and outputs corresponding control signals to the processor.

7. The electronic device of claim 6, wherein, when the touching exceeds the predetermined deactiviation threshold duration, the touch input signal analyzer does not output control signals for touching of the deactivated area.

8. The electronic device of claim 1, wherein release of the deactivated area after the predetermined deactivation threshold duration does not result in executing an action associated with any selectable item within the deactivated area.

9. The electronic device of claim 1, wherein the control circuit is further configured to detect release of the touching that exceeds the predetermined deactivation threshold duration and reactivate the deactivated area to permit touch selectability of items displayed on the display in the deactivated area.
